(19) United States
(12) Patent Application Publication
(10) Pub. No.: US 2014/0054440 A1
(43) Pub. Date: Feb. 27, 2014

(54) HANGING TOWEL HOLDER

(71) Applicants: Loralee Cardie, Runnemeade, NJ (US); Kristine Cardie, Mullica Hill, NJ (US)

(72) Inventors: Loralee Cardie, Runnemeade, NJ (US); Kristine Cardie, Mullica Hill, NJ (US)

(21) Appl. No.: 13/592,425

(22) Filed: Aug. 23, 2012

(51) Int. Cl. F16M 13/02

(52) U.S. Cl. 248/610

(57) ABSTRACT

A hanging towel holder is designed to be hung from a shower curtain rod, or similar elevated hanging device, over a bathtub or other water containing vessel. The holder has a first strap configured to circumscribe the bunched up top section of a towel and secure the holder in this position by use of Velcro® or similar connectors, and a second strap configured to loop over and attached to the back of the first strap. The second strap contains elastic material which, upon application of a pulling force on a towel hanging from the holder, results in the strap elongating. A person in the bathtub who requires a towel to wipe his or her eyes, face, etc., simply pulls down on the elevated towel. Release of the pulling force on the towel results in the holder returning to its resting position and the towel to its elevated position.

### BACKGROUND OF THE INVENTION

Individuals who take baths or otherwise clean themselves or enjoy soaking in a bathtub, often find the need to wipe soap, shampoo, or water from their eyes, face, nose, ears, etc. This routinely entails hunting for a towel or dry wash cloth, which is usually not within ready reach of the tub. The bather must either step out of the tub to locate a dry towel, which creates a wet/soapy mess on the bathroom floor, or, especially if a young child is involved, call out for help in getting a towel. When soap gets into the eyes of a child, not having ready access to something to wipe away the soap can be a harrowing experience for both parent and child. Having a dry towel within easy reach would be a welcome benefit.

However, there is currently no effective means to provide an individual in a bathtub or similar water containing bathing vessel, e.g. hot tub, spa, etc., with easy and quick access to a dry towel, whether a beach, bath, hand or other type of towel, for immediate use.

### SUMMARY OF THE INVENTION

It is thus the object of the present invention to provide a hanging towel holder which provides a towel to a bather who requires the immediate use of a towel to wipe soap or water from his or her eyes and face.

This and other objects are accomplished by the present invention, a hanging towel holder designed to be hung from a shower curtain rod, or similar stationary elevated hanging device, over a bathtub or other water containing vessel. The holder has a first strap configured to circumscribe the bunched up top section of a towel and secure the holder in this position by use of Velcro® or similar connectors, and a second strap configured to loop over and attach to the back of the first strap. The second strap contains elastic material which, upon application of a pulling force on a towel hanging from the holder, results in the strap lengthening and elongating. A person in the bathtub who requires a dry towel to wipe his or her eyes, face, etc., simply pulls down on the elevated towel for use. Release of the pulling force on the towel results in the towel holder returning to its shorter, resting position and the towel to its original, elevated position.

The novel features Which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a view of the towel hanging device of the present invention attached to a shower curtain rod.

FIG. 2 is a perspective view of the towel hanging device of the present invention.

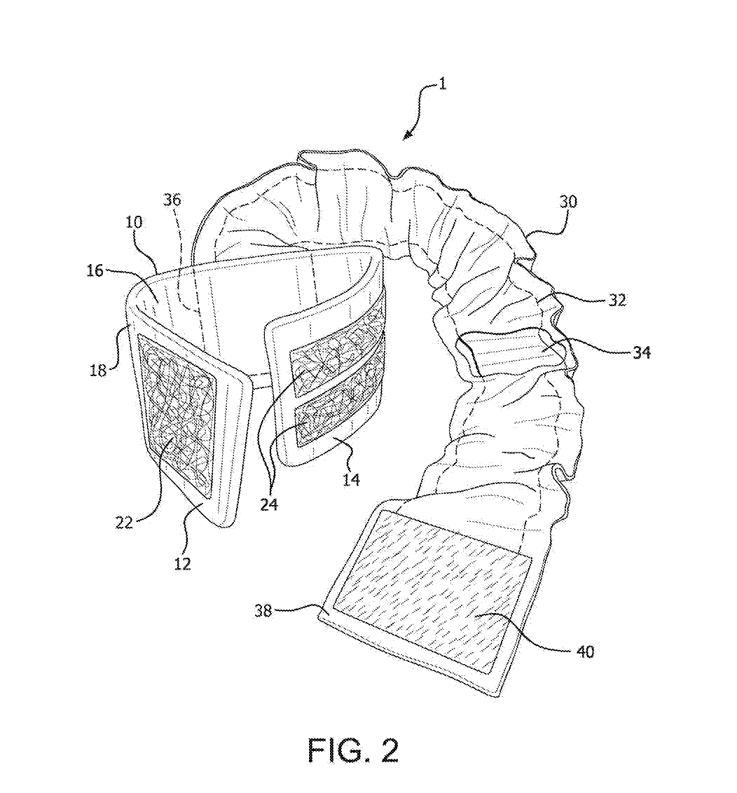

FIG. 3 is another perspective view of the towel hanging device of the present invention,

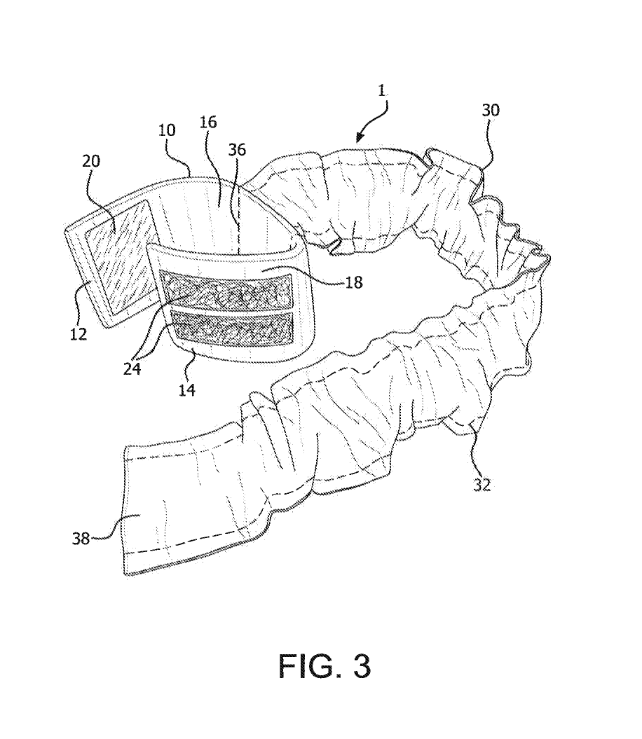

### DETAILED DESCRIPTION OF THE INVENTION

Hanging towel holder 1 is configured to circumscribe bunched up top section 4 of towel 2 and then to hang the towel in an elevated position on a shower curtain rod, hook, or equivalent supporting device.

Holder 1 comprises first strap 10, made of a high strength, yet flexible, waterproof material. Strap 10 has two end sections 12 and 14, inside surface 16, and outside surface 18. Velcro® connectors 20 and 22 are secured to inside surface 16 and outside surface 18, respectively, of end section 12. Velcro® connector 24 is secured to outside surface 18 at end section 14.

Holder 1 further comprises second strap 30, also made of high strength, flexible, waterproof material. Secured within strap 30, either by stitching 32 or other means, is resilient, elastic material 34, which extends substantially the length of the strap. Upon applying a pulling force on strap 30, elastic material 34 causes the strap to elongate. Releasing the force allows strap 30 to return to its shorter, resting length.

Strap 30 is sewn, secured, or otherwise permanently attached by equivalent means, at one of its two ends 36 to outside surface 18 of strap 10. Velcro® connector 40 is located on distal end section 38 of strap 30.

While Velcro® connectors are disclosed herein as the connecting devices for the invention, it is contemplated that snaps, buttons, clips or equivalent connection devices can be used in lieu of the Velcro® connectors.

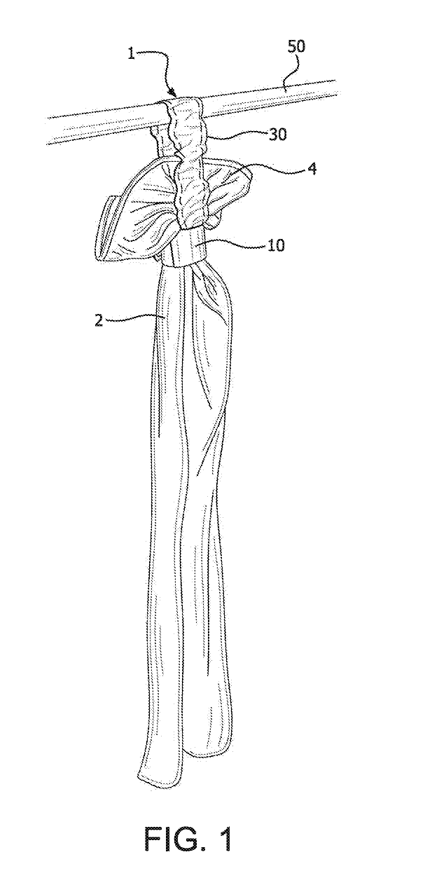

In use, top section 4 of towel 2 is bunched together. Strap 10 is wrapped around top section 4 in this bunched configuration and tightly secured in position by attaching connectors 20 and 24 together. Strap 30 is then looped up and positioned over strap 10, such that connector 40 of strap 30 attaches to connector 22 of strap 10. Holder 1 can then be hung on a hook or similar elevated holding device. If holder 1 is to be utilized with shower curtain rod 50, as shown in FIG. 1, strap 30 is looped over the rod before it is attached to connector 22 of strap 10. In this manner, holder 1 hangs down from shower curtain rod 50.

Once so positioned on shower curtain rod 50, a child or anyone in a bathtub who needs to wipe his or her eyes, face, etc. can simply pull down on hanging towel 2 to do so. Elastic member 34 allows strap 30 to lengthen and become elongated, to permit this easy towel access. Elastic material 34 will cause strap 30 to return to its shorter, resting length when the pulling force on towel 2 is released.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A hanging towel holder system comprising:
a towel having a top section;
a first strap for circumscribing the top section of the towel, said strap having two ends and first strap attachment means for removably securing the two ends of the strap together, around the top section of the towel; and
a second strap for hanging the towel in an elevated position, said second strap having two ends, one end being permanently connected to the first strap and the second end having second strap attachment means for removably securing the end of the second strap to the first strap, said second strap further comprising elastic means located within and extending substantially the length of the second strap for resiliently changing the length of the second strap.

2. The holder as in claim 1 wherein the first strap attachment means comprises two connector elements, one on each of the two ends of the first strap.

3. The holder as in claim 2 wherein said second attachment means comprises a connector element on the second strap configured to be removably secured to a corresponding connector element on the first strap.

4. The holder as in claim 3 wherein the first strap attachment means comprises two connector elements, one on each of the ends of the first strap.

5. The holder as in claim 1 wherein the elastic means comprises a resilient, stretchable material located within the second strap.

6. The holder as in claim 4 wherein the two connector elements, and the connector element on the second strap and the corresponding element on the first strap comprise hook and loop connectors.

7. A hanging towel holder system, said holder comprising:
a towel having a top section;
first strap means for circumscribing the top section of the towel, said strap means having attachment means for removably securing the strap means around said top section of the towel;
second strap means for hanging the towel in an elevated position, said strap means comprising elastic means located within and extending substantially the length of the second strap means for resiliently changing the length of the second strap means; and
second attachment means for removably securing the first strap means to the second strap means, whereby when the first attachment means is secured to the first strap means around the top section of the towel and the second attachment means is secured to the first strap means, the towel is configured to be hung in an elevated position.

8. The holder as in claim 7 whereby when the two ends of the first strap means are secured together around the top section of the towel and the second strap means is removably secured to the first strap means, the towel is configured to be hung in an elevated position.

9. The holder as in claim 7 whereby when the two ends of the first strap means are secured together around the top section of the towel and the second strap means is removably secured to the first strap means, the application of a pulling force on the second strap causes the elastic means to stretch and lengthen, and upon release of the force the second strap means returns to its original length.

10. The holder as in claim 8 whereby when the two ends of the first strap means are secured together around the top section of the towel and the second strap means is removably secured to the first strap means, the application of a pulling force on the second strap causes the elastic means to stretch and lengthen, and upon release of the force the second strap means returns to its original length.

11. The holder as in claim 7 wherein the first strap means comprises a strap with two ends and the first strap attachment means comprises two connector elements, one on each of the two ends of the strap.

12. The holder as in claim 11 wherein said second attachment means comprises a connector element on the second strap means configured to be removably secured to a corresponding connector element on the first strap means.

13. The holder as in claim 12 wherein the first strap means comprises a strap with two ends and the first strap attachment means comprises two connector elements, one on each of the ends of the strap.

14. The holder as in claim 7 wherein the elastic means comprises a resilient, stretchable material located within the second strap means.

15. The holder as in claim 13 wherein the two connector elements, and the connector element on the second strap means and the corresponding element on the strap comprise hook and loop connectors.
